(19) United States
(12) Patent Application Publication
(10) Pub. No.: US 2006/0095840 A1
(43) Pub. Date: May 4, 2006

(54) Method and system for capturing website information

(76) Inventor: Jen-Hwang Weng, Jungli City (TW)

Correspondence Address: BRUCE H. TROXELL, SUITE 1404, 5205 LEESBURG PIKE, FALLS CHURCH, VA, 22041, US

(21) Appl. No.: 11/236,603

(22) Filed: Sep. 28, 2005

(30) Foreign Application Priority Data
Oct. 29, 2004 (TW) 93133145

(51) Int. Cl. G06F 17/24; G06F 17/21; G06F 17/30

(52) U.S. Cl. 715/530; 715/513; 707/3

(57) ABSTRACT

A method for capturing website information through a container is introduced. The container is an application software having at least a function of web page browsing. The method comprises the steps of: providing a connection module through the container for accepting a wordlist, forwarding the wordlist to a search engine via a network, the search engine searching a web page related to the wordlist, the web page being presented to the container via the network, and providing an edit module through the container to edit contents of the web page.

### BACKGROUND OF THE INVENTION

(1) Field of the Invention

The invention relates to a method and a system for capturing website information, and more particularly to a method and a system that are suitable to search on-line website information and can process browsing, searching, capturing, editing and storing data in a real-time manner.

(2) Description of the Prior Art

With the prosperity of broadband network, emergence of various commercial opportunities into the network contains has become the mainstream operation in business. It is obvious that the network has played an important role as a platform nowadays for information exchange and various commercial behaviors.

Apparently, plenty of information is accessible anytime to ordinary people through a simple Internet application. It has also become an instinct that modem people search information through world-wide webs or networking. To better utilize the network in searching preferable materials, people may meet a situation that they find too much more information, useful and trivial, than they indeed require. Such a situation makes a need of abstracting all the useful information first, and then people can go over those abstracted information in a later time before they can determine which contents are really needed. However, abstracting all searched information is, in fact, not so easy, and lack of the abstracting means usually makes those tremendous searched materials look useless.

Referring to FIG. 1, a schematic view for a conventional operation of capturing information through a network is shown. Generally speaking, a conventional on-line searching method is to firstly utilize a web browser A120 to connect a search engine A110 through a network A100, and then a keyword can be keyed in to search related information. However, the browsed web pages are not guaranteed to be “REALLY” related. Therefore, a review through page by page is needed to screen these web pages. Further, even though a relevant web page is located, there is also no guarantee that all the information presented in the web page are “NOW” useful to the searcher. To benefit later usage of these searched web pages, abstracting information on each or important web pages is needed.

It is well known that the web browser A120 can only provide one-way browsing. That is to say that a content editing is forbidden in a browsing operation. If part of contents in the web page need further editing, a “Save as . . . ” function of the browser A120 is usually used to store the concerned web page A121. In a typical editing operation, the stored page A121 can be retrieved and then the required information is cut to an editor A140 through a clipboard A130, in which the editor A140 can be the Word, the FrontPage, the WordPad and so on. In the case that the number of web pages in the memory are big, labors for retrieving, surveying, screening, cutting and further pasting concerned materials to the editor A140 page by page, and finally editing these abstracted materials in the editor A140 will be definitely heavy and notorious, though necessary. In particular, most of the editors A140 are not directly connected to the network 100.

Referring to FIG. 2, a schematic view of another conventional operation of capturing information through a network is shown. Compared to FIG. 1, this operation of FIG. 2 does not require the web pages A121 to be stored in the memory, but alternatively the editor A140 is on standby while the web browser A120 is on-line with the search engine A110 through the network A100. That is to say that, in the operation of FIG. 2, at least three major software, the web browser A120, the clipboard A130 and the editor A140, need to be activated and thus occupy a huge space of the computer memory. Moreover, the tedious surveying-cutting-pasting-editing job as well as necessary frequent shifting among software still makes the operation of FIG. 2 notorious.

It is well known in the art that the web browser A120 can work only while it is connected with the search engine A110, and the browsing and the editing cannot be processed at the same time. Therefore, “real-time keyword search” in a browsing web page is never true. To compensate the shortcoming, some search engines like Google as shown in FIG. 3 can provide a toolbar A310 for the user to plug into the web browser A120 and to make easy the keyword search while the user is browsing the web pages. In utilizing the toolbar A310, a word or a word list by typed or by dragged from the web page A340 is firstly keyed into a word window A320 of the toolbar A310, a search button A330 captioned by “Search Web” is clicked, and then those words shown in the window A320 can then be sent to Google for an instant keyword search. Upon such an arrangement, a quasi-real time search can be obtained. Yet, the editing upon the already-browsed web pages still can't be processed simultaneously with a new keyword search.

In need of editing the web page on line, some technology has integrated the editor and the browser into a web page. As shown in FIG. 4, the web page browser A120 and the editor A140 are integrated in the same web page so that, while a web page is interested, the user can call up the FrontPage A141 directly to edit the page. In FIG. 5, the FrontPage A141 is editing edit-able contents in the web page, in which the edit-able contents are highlighted by dashed brackets. However, if there is a need to make editing across two or more web pages, a clipboard of the operation system is still required. Also, while in editing the edit-able contents by the FrontPage A141, the browser is suspended. To resume a new search, the editing (i.e. the FrontPage A141) needs to be interrupted first and then the browser can be connected to a search engine for the new search.

In the previous application, the web page browser and the editor are shown to appear in the same page, but switching between them is unavoidable in operation. Referring to FIG. 6, a schematic view showing data flow between a web browser A120 and an editor A140 is present. In this scheme, a clipboard A130 belonging to the operation system is actually used as the bus to exchange information between the browser A120 and the editor A140. Without the clipboard A130, a selected content shown in the browser's page cannot be captured and forwarded to the editor A140. Obviously, such an application involving the switching through the clipboard A130 of the operation system is still inconvenient to users.

As stated, current web browser cannot provide a satisfied method for real-time capturing the network information. Shortcomings resulted from that include:
1. While in browsing a web page, related information concerning the keywords can not be searched in a real-time fashion;
2. While in a state of browsing the web page, contents in the web page cannot be edited;
3. While in editing a web page, a new search through a network search engine cannot be processed; and
4. A clipboard is needed as the information-exchange bus between the editor and the browser.

### SUMMARY OF THE INVENTION

Accordingly, it is an object of the present invention to provide a method for real-time capturing website information and a system for achieving the same, in which the system integrates an web browser and some related module as described below.

The method for capturing website information in accordance with the present invention comprises:
1. providing a connection module for real-time connecting a current web page to a search engine for a possible search upon keywords in the current web page;
2. providing an edit module for real-time editing contents of the current web page;
3. while in editing the current web page, providing the connection module also to the edit module for processing a possible search upon another keyword of the contents; and
4. integrating functions of web page browsing and editing through the connection module so that no switching between various interfaces is needed and labors for conventional editing as described above can be substantially lessened.

All these objects are achieved by the method and the system for capturing website information described below.

### BRIEF DESCRIPTION OF THE DRAWINGS

The present invention will now be specified with reference to its preferred embodiment illustrated in the drawings, in which:

FIG. 1 is a schematic view showing a conventional operation of capturing information through a network;

FIG. 2 is a schematic view showing another conventional operation of capturing information through a network;

FIG. 3 shows a web page including a tool bar of a web browser;

FIG. 4 shows a web page including a web browser and an editor;

FIG. 5 shows a web page showing a FrontPage editor in an editing state;

FIG. 6 is a schematic view showing data flow between a web browser and an editor;

FIG. 7 shows a relationship among major operations of a website search;

FIG. 8 shows a preferred system for capturing website information in accordance with the present invention;

FIG. 9 is a flowchart of a preferred method for capturing website information in accordance with the present invention;

FIG. 10 is a web page presenting a real-time web browser; and

FIG. 11 shows another system for capturing website information in accordance with the present invention.

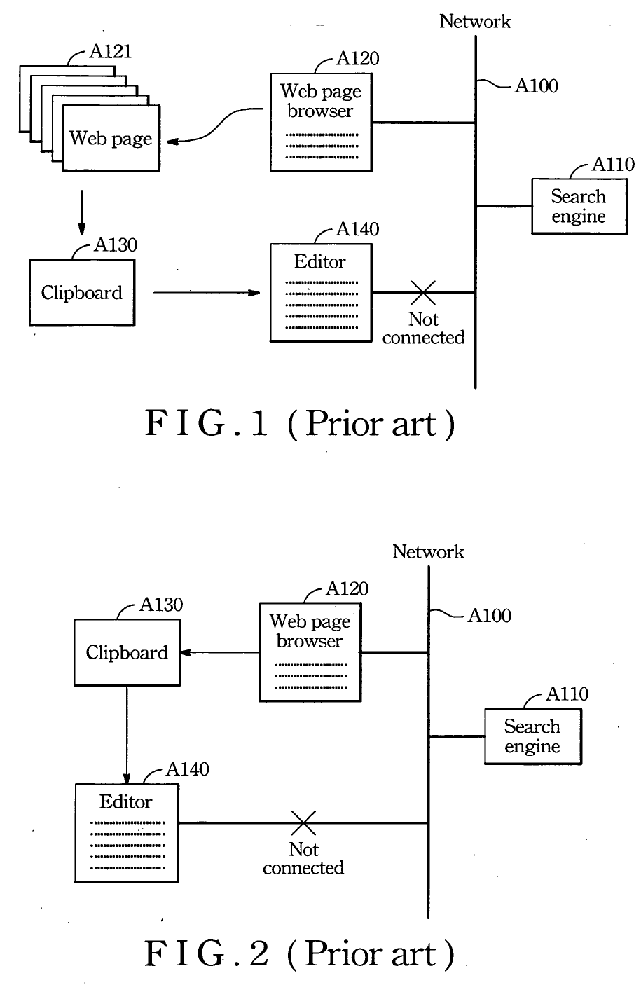

### DESCRIPTION OF THE PREFERRED EMBODIMENT

The invention disclosed herein is directed to a method and a system for capturing website information. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

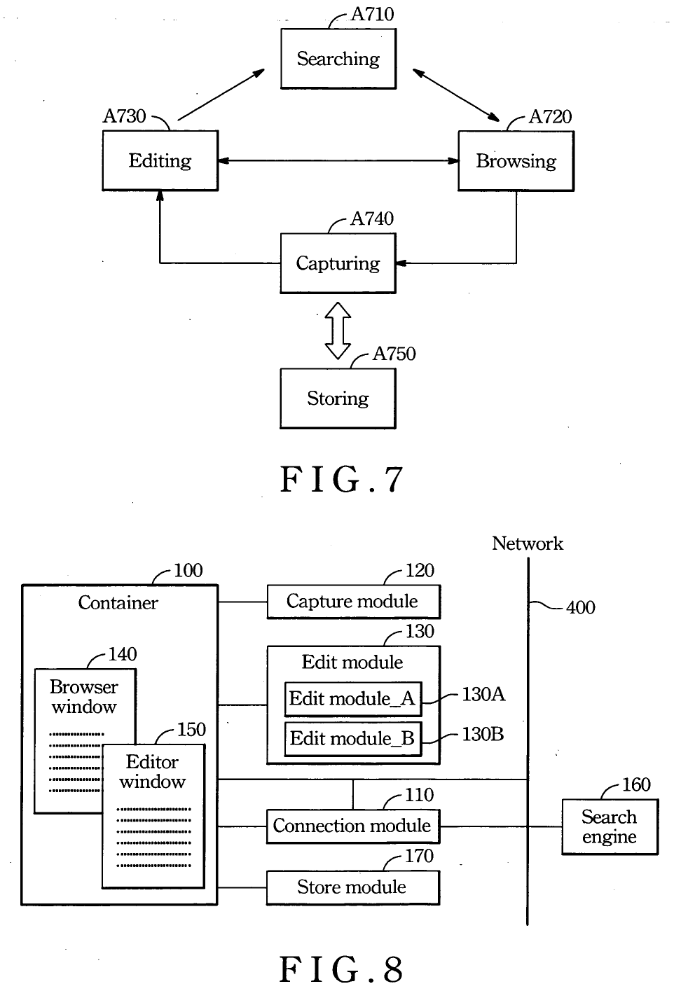

Referring now to FIG. 7, a relationship among major operations of a website search is shown. To swiftly and real-time capture website information basically involves four major operations: searching A710, browsing A720, editing A730 and capturing A740. Through repeatedly performing these four operations, a useful material can then be located in various web environment and can be stored (storing A750) into a local memory facility.

In a typical website search, searching A710 and browsing A720 are reciprocally processed to locate the desired information, and then capturing A740 can be performed to capture the concerned contents in related web pages for further editing A730. While in editing A730, searching A710 and browsing A720 may be still needed to process further search upon a keyword in the editing contents. To better manipulate among these four operations, keeping these four operations on line simultaneously is extremely important and such a goal is definite the topic of the present invention.

Contrary to the conventional art in capturing website information as described in the background section, the method for capturing website information in accordance with the present invention comprises:
1. providing a connection module for real-time connecting a current web page to a search engine for a possible search upon keywords in the current web page;
2. providing an edit module for real-time editing contents of the current web page;
3. while in editing the current web page, providing the connection module also to the edit module for processing a possible search upon another keyword of the contents; and
4. integrating functions of web page browsing and editing through the connection module so that no switching between various interfaces is needed and labors for conventional editing as described above can be substantially lessened.

In item 1, the connection module is used to integrate the web browser in action and a standby search engine for an expecting on-line keyword search. The keyword search can be a single word or a wordlist. The search engine can be any search engine in the market such as Google, Yahoo and so on.

In item 2, the edit module and the web browser are co-existent in an on-line manner so as to have the edit module able to edit the contents of the current browsed web page. In the present invention, the edit module can transform a web page of the web browser from a browsing state into an editing state. In another application, the edit module can also utilize the DHTML (Dynamic hyper text markup language) to perform the transformation from the browsing state to the editing state.

In item 3, the connection module can also connect with the search engine for further performing a keyword search upon a keyword of the contents of the web page that is under editing.

In item 4, an application program can be introduced to edit the aforesaid modules so that the browsing function can be integrated to the edit module. Upon such an arrangement, the web page under the browsing state can be edited at the same time. In another embodiment, an application software can include both the browse module and the edit module so that the software can process the browsing and the editing at the same time. In addition, the edit module can be included in a web page so that, while the browser browses a web page, the browser can utilize the edit module directly to edit the contents of the web page.

In the present invention, a capture module can be integrated to the browser so that the interesting contents in the browsed web page can be directly captured for further editing. The tedious conventional operation in copying and pasting the contents can thus be avoided.

In the present invention, a store module for storing the edited contents of the web page can be integrated with the browser.

As stated, by organizing the application program to include all the modules mentioned above, the required content of the browsed web page can be easily and quickly captured. One thing to be noted is that the application program is better installed to the user end. However, to those foreign information providers or searcher such as Google, Yahoo and so on, the present method can still prevail by including the aforesaid connection module, the edit module and the capture module to their web pages. Then, even without the application program installed at the user end, the user can also access these modules of the present invention through browsing these web pages to perform browsing, searching, capturing, editing and storing the desired network information.

Referring now to FIG. 8, a preferred embodiment of the system in accordance with the present invention is shown. The system includes a container 100, realized as an application software such as a web page browser. The container 100 can provide a function of browsing web pages and can connect with a connection module 110, a capture module 120 and an edit module 130. In the container 100, a browser window 140 (simply symbolized as BW) and an edit window 150 (simply symbolized as EW) are included. The BW 140 is used for browsing web pages, and the EW 150 is used for editing contents of the browsed web pages. In particular, the BW 140 and the EW 150 can be combined into a single window, which can provide an editing function during web page browsing and provide a browsing function during content editing. In the present invention, the container 100 can also be a user-made application program who has at least a browsing function. For example, the user can utilize Visual Basic (VB) language to program the application program. By referring to the Internet explorer objects or the Web Browser objects, the application program can then have at least a website browsing function.

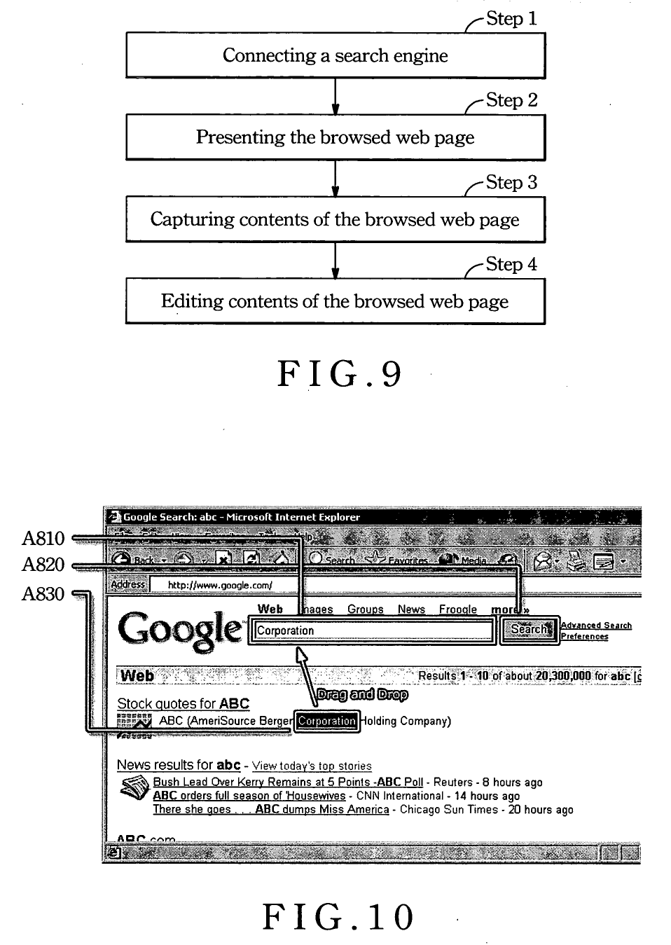

Referring now to FIG. 9, a preferred embodiment of the method in accordance with the present invention is shown. The method comprises steps of (numerals referred to FIG. 8):
Step 1: transmitting a wordlist from the container 100, through the connection module 110, to a search engine 160 via a network;
Step 2: the searching engine 160 processing a network search, based on the wordlist, to locate a web page of a website, and the web page being forwarded to show on the BW 140 of the container 100 through the network 400 and the connection module 110;
Step 3: contents of the web page in the BW 140 being captured to the EW 150 by the capture module 120; and
Step 4: the edit module 130 editing the captured contents of the web page in the EW 150.

In Step 1, the connection module 110 can provide an input interface to receive the wordlist. Preferably, the input interface can present in the browsed web page loaded in the container 100. Alternatively, the application program of the input interface can be a plug-in to the container 100, or directly included in the container 100.

Referring now to FIG. 10, the input interface is directly shown on the browsed web page of the container 100. In this illustration, Google is selected as the web page, and IE is the container 100. As shown, a text box A810 is shown to receive a wordlist. When the wordlist is keyed in and a “search” button A820 next to the text box A810 is clicked, the wordlist can be immediately sent to Google for a related information search. The text box A810 can accept a wordlist directly input from an input device such as a keyboard, or a selected wordlist A830 of the contents of the web page.

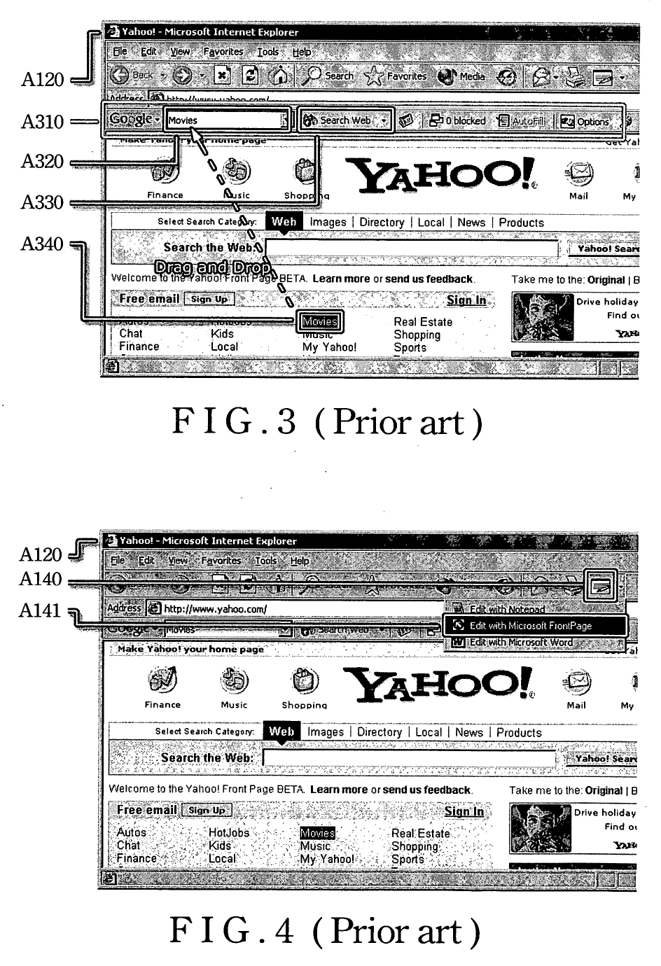

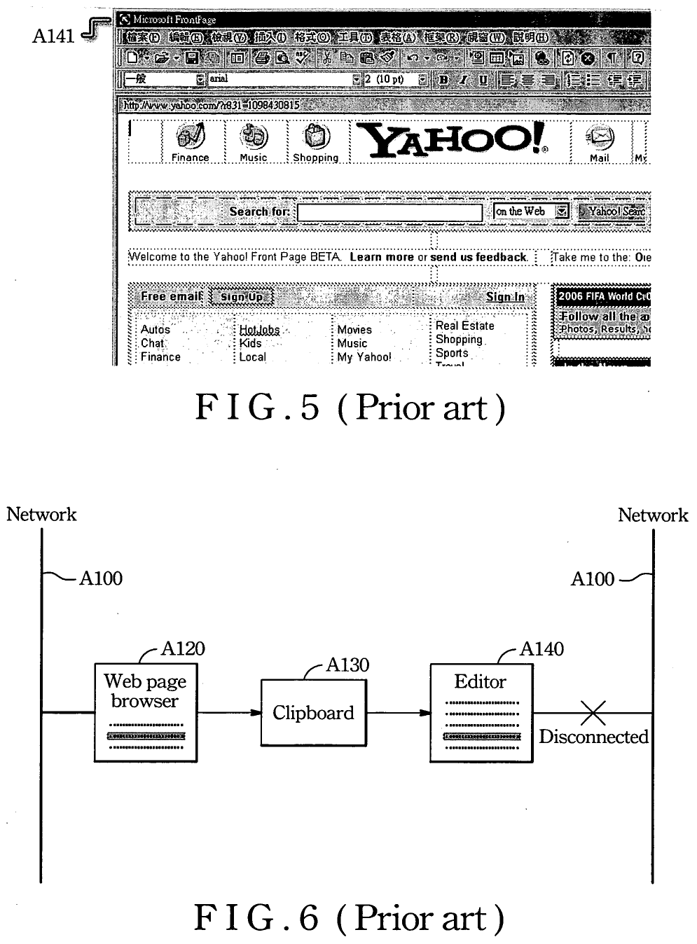

Referred back to FIG. 3, the input interface is shown to be a plug-in (the tool bar A310 provided by Google) to the container 100 (IE). The tool bar A310 includes a text box A320 and a “Search Web” button A330. Operations regarding the text box A320 and the button A330 are the same as that described in the previous paragraph.

Referring now to FIG. 8, in the case that the input interface is included in the container 100, the only qualification for this input interface is that it can accept a wordlist and can forward this wordlist to the search engine 160 through the network 400.

In the present invention, the connection module 110 can connect directly to the container 100 for receiving a wordlist selected from a web page of the container 100. The wordlist is then forwarded to the search engine 160 through the network 400. In this application, the connection module 10 can be included in the browsed web page of the container 100, plugged in to the container 100, or directly in the container 100.

The connection 110 of the present invention is used to forward a wordlist from the container 100 to the search engine 160 through the network 400, and also be used to send a browsed web page to show on the BW 140 of the container 100. To take Google for example, while a wordlist in the web page is selected and so triggers the connection module 110, the connection module 110 is activated to capture the wordlist by utilizing a program code {selected wordlist=document.selection.createRange.text} or using a system's clipboard coded as {selected wordlist=Clipboard.GetText}. As soon as the connection module 110 captures the selected wordlist, the selected wordlist is forwarded to Google for a website search, coded as {BW.nevigate “http://www.google.com/search? ie=big5&hl=zh-TW&q=” & “selected wordlist”}

In this coding, the connection module 110 also navigate the BW 140 of the current website to the browsed web pages. That is to say that the search result can be present as a web page to the BW 140 through the network 400.

In the present invention, the search engine 160 can be any search engine in the market such as Google, Yahoo, or any on-line information provider.

In Step 2, the search result is present to the BW 140 as a web page showing a list of browsed websites. By using a mouse to click one website, the related web page can then be popped up. In showing the selected web page, if a new window is designated to illustrate the selected website, the connection module 110 can navigate the current website of the BW 140 to the selected website so that the web page of the selected website can be present to the BW 140. Following is coding for a typical example showing the foregoing operation,

```
{If
  Lcase(BW.document.activeElement.tagName) = “a”
Then
    UrlNow =
    BW.document. activeElement.getAttribute(“href”)
    BW.navigate UrlNow
End If }
```

In the coding, UrlNow is the selected website, and BW.navigate is used to navigate the BW 140 to the selected website. Upon such a coding, the web page of the selected website can then show in the BW 140, through the network 400.

In Step 3, by integrating the capture module 120 and the container 100, the container 100 can then capture contents of the web page in the BW 140 and transmit the captured contents to the EW 150. The capture module 120 can be included in the browsed web page in the container 100, plugged in to the container 100, or included directly in the container 100.

In the present invention, the capture module 120 can shift the entire web page in the BW 140 to the EW 150. Coding for this operation can be:
{EW.document.body.outerHTML=BW.document.body.outerHTML}

In the case that only a portion of the contents in the web page is required, the capture module 120 can also capture the selected portion of the contents in the BW 140 and send it to the EW 150. Coding for this operation can be:

{ EW.document.body.innerHTML =
BW.document.selection.createRange.htmlText }

By this coding, the selected portion in the BW 140 can be pasted into the <body> of the EW 150. In addition, the captured contents of the selected page can also be pasted to other objects of the web page such as <DIV>, <FONT> and so on.

In the present invention, functions of the capture module 120 can also be performed by introducing the system's clipboard. In this application, the selected contents in the BW 140 is copied firstly to the clipboard, and then the selected contents is removed from the clipboard to paste at a predetermined location in the EW 150. In the following example, a program code utilizes a virtual basic function to form an effect of simultaneously depressing the Ctrl key and the C key so as to copy the selected contents in the BW 140 to the clipboard.

{ Clipboard.clear
Sendkeys “\hat{ }c” }

Further, another virtual basic function as follows is utilized to generate an effect of simultaneously depressing the Ctrl key and the V key so as to copy the selected contents in the clipboard to the cursor position in the EW 150.

{ EW.focus
Sendkeys “\hat{ }v” }

In Step 4, the edit module 130 includes at least one of an edit module_A 130A and an edit module_B 130B. The edit module 130 integrates with the container 100 so as to have the container 100 able to edit contents of the browsed web page in the EW 150 or to set up styles of objects of the browsed web page. The edit module 130 can be included in the browsed web page in the container 100, plugged in to the container 100, or included directly in the container 100.

The edit module_A 130A can integrate with the container 100 to transform the web page in the EW 150 to an editable state so that the contents of the web page can be edited in the EW 150. For example, coding to transform the entire web page in the EW 150 to the editable state can be as follows.

```
{ EW.document.body.outerHTML =
    “<body contenteditable>”
        & EW.document.body.innerHTML
        & “</body>” }
```

In the coding, the contenteditable implies that the web page in the EW 150 is already at an editable state. As long as the web page is editable, the contents of the web page in the EW 150 can then be edited through a proper input device such as a keyboard, a mouse, or any the like.

The edit module_A 130A can also be used to alter the styles of the objects of the web page. For example to change font of a character object (to a Times New Roman style) through clicking by a mouse, coding can be as follows.

{ SrcID = window.event.srcElement.id }
{ document.all(SrcID).style.fontFamily = “Times New Roman” }

The edit module_B 130B can integrate with the container 100 to have the EW 150 include a web page so that the contents of the web page can be edited under a browsing state. That is to say that, even the web page in the EW 150 is at the browsing state, a DHTML provided by the edit module_B 130B can be used to change the contents of the web page. Process to perform the aforesaid change can be: (In advance, a cursor is established in the web page to locate the position where the editing can occur.)
Clicking the web page once to set up the cursor position;
Moving the cursor with direction keys;
Keying in the texts;
Inserting any object to the web page; and
Setting the style of the object.

In the step of “Clicking the web page once to set up the cursor position”, the cursor shown as a twinkling icon has an identification data of “CursorPic”. When the mouse clicks the web page to trigger a mousedown event, coordinates (x, y) of the mouse can be obtained. At the same time, a TextRange object is created and named as a CursorRange. The CursorRange is moved to the (x, y) by a moveToPoint method so as to determine attributes of offsetLeft and offsetTop of the CursorRange. Then, the position of the cursor can be decided.

```
{ CursorPic.posLeft =
      CursorRange.offsetLeft + scrollLeft
  CursorPic.posTop =
      CursorRange.offsetTop + scrollTop }
```

Thereby, the icon can then moved to the position where the clicking occurs. In the present invention, the icon can also be replaced by other object of the web page, in which the object can accept text input. Such an object will twinkle under an editing state. For example, the object <FONT contenteditable></FONT> can replace the icon. For the FONT object is at the editing state and is focused, a twinkling cursor can appear inside the FONT object.

In the step of “Moving the cursor with direction keys”, the moving direction of the cursor can be determined by the KeyCode as soon as a specific direction key on the keyboard is depressed to trigger a KeyDown event. In the moving, every hit on the direction key accounts for a shift over a character. Further, the offsetLeft and offsetTop of the CursorRange can be used to locate the icon of the cursor, as described above.

In the step of “Keying in the texts”, the aforesaid CursorRange is immediately generated as soon as the cursor is moved to a desired text-input position. Simultaneously, a text box for receiving input texts is positioned under the cursor position. The text box formed as a square with 0-width borderlines. Coding for establishing the text box can be as follows.

```
{ <INPUT TYPE = “text” ID = “insertObj” VALUE = “ ”
    STYLE = “position:absolute; z-index:1; width:1;
    height:16px; font-family:Arial; font-size:16px;
      border:0; display:none”> }
```

In the coding, {width:1} stands for a width of 1 for the text box, {border:0} stands for a width of 0 for borderlines of the text box, and {display:none} stands for the text box being hidden. The width of the text box can increase with the length of the input text so that the input text can be inserted and shown at a specific point positioned by the cursor. After the text input is done, the input text is pasted to the cursor position by the CursorRange.pasteHTML method so as to present the input text under the browsing state. In another application of the present invention, the text box can be substituted by the foregoing <FONT contenteditable></FONT> object. For the FONT object is already at the editing state, texts can be input to the corresponding cursor position. As soon as the input is over, the input text in the FONT object can be pasted to the cursor position by the CursorRange.pasteHTML method. If a change on the font of the text is needed, altering of the font-family or the font-size in the style of the <FONT> object is necessary.

In the step of “Inserting any object to the web page”, a CursorRange object is immediately generated as soon as the cursor is moved to a position to be inserted an object of the web page. Then, the object is pasted to the cursor position by the CursorRange.pasteHTML method such that the inserted object can be shown on the web page under the browsing state. For example, coding for inserting a picture object can be <IMG SRC=“MyDog.gif”>. Further, coding of {CursorRange.pasteHTML “<IMG SRC=‘MyDog.gif’>”} can be used to paste the figure (MyDog.gif) to the cursor position of the web page under the browsing state.

In the step of “Setting the style of the object”, the operation of this step is similar to the foregoing one with respect to the edit module_A.

In the present invention, the edit module_A 130A is used to transform a web page from a browsing state to an editing state and further to edit contents of the web page. On the other hand, the edit module_B 130B is used to edit “directly” the contents of the web page under the browsing state. That is to say that, in the edit module_B 130B, editing can be performed upon contents indexed by the cursor while the other contents are left in the browsing state.

The edit module_A 130A is simpler than, also inferior to, the edit module_B 130B. For example, after the edit module_A 130A moves a web page to an editing state, some of the web page objects may loose their original settings though editing the contents is feasible. Those infertile objects may include at least:
a. hyperlink objects;
b. marquee objects;
c. hidden objects (would be surfaced); and
d. button objects.

On the other hand, for the editing state only exists at the cursor position, the edit module_B 130B can avoid the aforesaid shortcomings.

While the embodiment shown in FIG. 8 is at the editing state, the connection module 110 and the search engine 160 can be utilized to perform on-line search.

As shown in FIG. 8, the system provides a store module 170 connecting the container 100 to store the edited contents of the web page. The store module 170 can be included in the web page retrieved in the container 100, plugged in to the container 100, or included directly in the container 100. The corresponding storage format can be a HTML form, a wordlist or any text format. For example, the store module 170 can introduce the FileSystemObject object of the virtual basic language to store the edited contents in an HTML file or a text file. For example, the store module 170 can also introduce the Word object of the virtual basic for application to store the edited contents in a Word file. For example, the store module 170 can introduce the ADO object of the virtual basic language to insert a data bank.

In this embodiment, the container 100 can provide the aforesaid modules through the following three pathways.
1. The modules are included in a web page browsed by the container 100. The modules in the web page are compiled by the container 100 to provide their functions.
2. In the case that the container 100 is an application software as a website browser, the modules are plugged in to the application software so as to provide their functions through the software. For example in FIG. 3, a Google tool bar (the modules) is plugged in to the Yahoo web page.
3. The modules are included directly in the container 100 formatted as an application software. Functions of the modules can be performed through the application software.

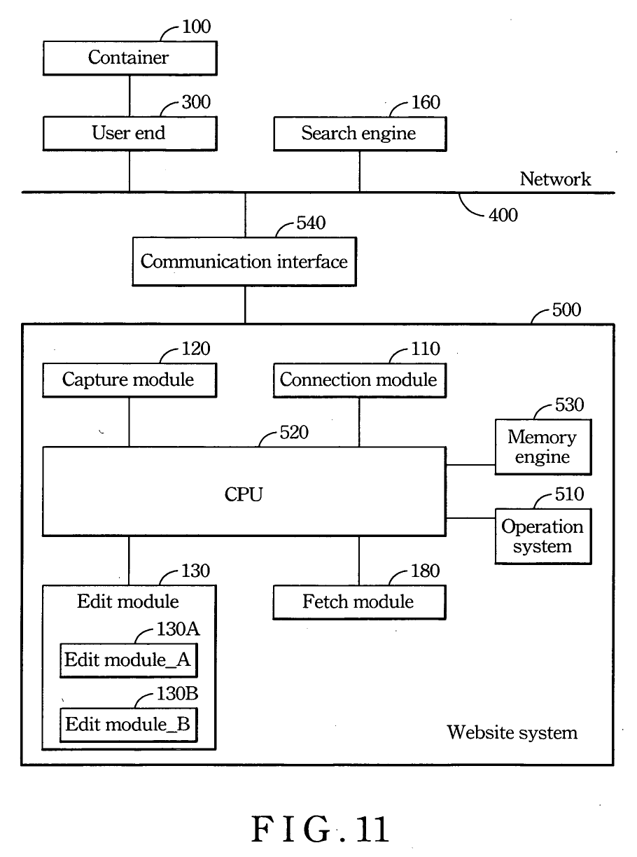

Referring now to FIG. 11, another system 500 for capturing website information in accordance with the present invention is shown. The website system 500 utilizes a communication interface 540 to establish a communication link with a container 100 of the user end 300. The major part of the communication link is the network 400. The container 100 is an application software having at least the website browsing function. The website system 500 forwards related modules to the user end 300 through the communication interface 540 and the network 400 so as to integrate those modules and the container 100. Upon such an arrangement, while the container 100 is at a browsing state, a search engine 160 can still be used simultaneously to perform website browsing, searching, capturing, editing and storing the website information. As shown, the website system 500 includes at least:
an operation system 510 for managing internal resources inside the website system 500 and for controlling various I/O devices and users' programs;
a CPU 520 for performing internal calculations and various job cooperation;
a memory 530 for storing internal data and programs of the website system;
a communication interface 540 for establishing a communication link between a user end 300 and the website system 500;
a connection module 110, utilizing the communication interface 540 and the network 400 to integrate with a container 100 of the user end 300 so as to make the container 100 able to accept a wordlist, the wordlist further being forwarded to a search engine 160 through the network 400 for searching a web page based on the wordlist, the web page being presented to the container 100 through the connection module 110 and the network 400; and
an edit module 130, utilizing the communication interface 540 and the network to integrate with the container 100 of the user end 300 so as to edit contents of the web page in the container 100.

In the website system 500, the container 100 can be an application software at least having a website browsing function, such as a web page browser.

The connection module 110 as described above in the previous embodiment can accept a wordlist through an input interface or directly accept a wordlist selected from the web page of the container 100.

The edit module 130 as described above can include at least one of an edit module_A 130A and an edit module_B 130B.

The website system 500 can further include the search engine 160. The search engine 160 can be the Google, Yahoo, or any on-line information provider.

The website system 500 can further include a capture module 120. The capture module 120 utilizes the communication interface 540 and the network 400 to integrate with the container 100 of the user end 300 so as to capture portion edited contents of the web page in the container 100. operations of the capture module 120 are the same as that stated in the previous embodiment.

The website system 500 can further include a fetch module 180. The fetch module 180 utilizes the communication interface 540 and the network 400 to integrate with the container 100 of the user end 300 so as to fetch the edited contents of the web page in the container 100 back, again through the communication interface 540 and the network 400, to the website system 500. Also, the fetched contents can be stored in the website system 500. For example, the fetch module 180 can utilize a built-in remote data service (RDS) object of the Internet Explorer to fetch back the edited contents as the fetched contents, and the fetched contents can be stored according to an HTML format, a text format, or any existing literal format. In the case that either the HTML format or the text format is chosen, a FileSystemObject object of the VB can be used. In the case that a Word format is selected, the Word object of the VBA can be used. Also, in the case that the contents are to be inserted into the memory, an ADO object of the VB can be used.

In this embodiment, the container 100 utilizes following two pathways to integrate various modules.
1. The website system 500 includes all aforesaid modules in a single web page. The container 100 then downloads the web page so as to access the modules through necessary compilation.
2. The website system 500 can provide the aforesaid modules for the user end 300 to install as a plug-in to the container 100. In the case that the container 100 is a web page browser, say Google, to provide a tool bar for the browser to plug in, the tool bar can provide functions of the aforesaid modules to the browser so as to make the browser capable of editing contents while it is even at a browsing state.

While the present invention has been particularly shown and described with reference to a preferred embodiment, it will be understood by those skilled in the art that various changes in form and detail may be without departing from the spirit and scope of the present invention.

I claim:

1. A method for capturing website information through a container, the container being an application software with at least a function of web page browsing, the method comprising the steps of:
providing a connection module through the container for accepting a wordlist, the wordlist being further forwarded to a search engine via a communication link, the search engine searching a web page related to the wordlist, and then the web page being presented to the container via the communication link; and
providing an edit module through the container to edit contents of the web page.

2. The method for capturing website information through a container according to claim 1, wherein said communication link is a network.

3. The method for capturing website information through a container according to claim 1, wherein said container is a web page browser.

4. The method for capturing website information through a container according to claim 1, wherein said search engine is an on-line information provider.

5. The method for capturing website information through a container according to claim 1, further comprising the steps of:
providing a capture module through said container to capture part of said contents of said web page; and
said edit module to edit the part of said contents in said container.

6. The method for capturing website information through a container according to claim 1, wherein said wordlist is obtained through an input interface.

7. The method for capturing website information through a container according to claim 1, wherein said wordlist is obtained through a selection operation upon said contents.

8. The method for capturing website information through a container according to claim 1, wherein said edit module sets said web page to an editing state so as to edit said contents in the editing state.

9. The method for capturing website information through a container according to claim 1, wherein said edit module edits said contents directly in a browsing state of said web page.

10. The method for capturing website information through a container according to claim 1, further comprising a step of providing a store module through said container to store said contents of said web page.

11. A website system for capturing website information, utilizing a communication link to forward a plurality of modules to integrate with a container of a user end, the container being real-time connected with a search engine, the container being an application software having at least a function of web page browsing, the website system comprising:
a communication interface for establishing the communication link between the user end and the website system;
a connection module, integrating with the container through the communication interface so as to have the container accept a wordlist, the wordlist being further forwarded to a search engine via the communication link, the search engine searching a web page related to the wordlist, and the web page being presented to the container via the communication link; and
an edit module, integrating with the container through the communication interface so as to edit contents of the web page in the container.

12. The website system for capturing website information according to claim 11, wherein said communication link is a network.

13. The website system for capturing website information according to claim 11, wherein said search engine is located in the website system.

14. The website system for capturing website information according to claim 11, wherein said search engine is an on-line information provider.

15. The website system for capturing website information according to claim 11, wherein said container is a web page browser.

16. The website system for capturing website information according to claim 11, further comprising:
a capture module, integrating with said container of said user end through said communication interface so as to capture part of said contents of said web page;
wherein said edit module edits the part of contents in said container.

17. The website system for capturing website information according to claim 11, further comprising a fetch module integrating with said container of said user end through said communication interface so as to fetch said contents of said web page back to said website system through said communication link and said communication interface, after said contents are edited by said edit module.

18. The website system for capturing website information according to claim 11, wherein said wordlist is obtained through an input interface.

19. The website system for capturing website information according to claim 11, wherein said wordlist is obtained through a selection operation upon said contents.

20. The website system for capturing website information according to claim 11, wherein said edit module sets said web page to an editing state so as to edit said contents in the editing state.

21. The website system for capturing website information according to claim 11, wherein said edit module edits said contents directly in a browsing state of said web page.

22. The website system for capturing website information according to claim 11, further comprising:
an operation system for managing internal resources inside said website system and for controlling various I/O devices and users' programs;
a CPU for performing internal calculations and various job cooperation; and
a memory for storing internal data and programs of said website system.
